(19) United States
(12) Patent Application Publication
(10) Pub. No.: US 2009/0064823 A1
(43) Pub. Date: Mar. 12, 2009

(54) HOSE CLAMP PLIERS

(76) Inventor: CHUAN MAO HUANG, TAICHUNG CITY (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/853,251

(22) Filed: Sep. 11, 2007

(51) Int. Cl. B25B 27/10

(52) U.S. Cl. 81/9.3

(57) ABSTRACT

A hose clamp pliers comprises first and second pliers bodies axially combined together by a pivot pillar for forming operating segments and working segments thereon including fitting seats disposed on the front ends thereof for fitting clamping members therein individually, the clamping members including positioning portions for accommodation various types of hose members mounted on one ends thereof, and including shanks with smaller diameters coupled on another ends thereof and inserting through the fitting seats respectively, the inner end surfaces of the positioning portions being biased against the inner end surfaces of the fitting seats respectively, and one ends of the shanks projecting out of the outer end surfaces of the fitting seats, the shanks including holes formed therein for receiving compression springs including balls placed on the free ends thereof and pushed out of the shanks thereby for being retained on the outer end surface of the fitting seats respectively, thus quickly replacing different sizes or shapes of clamping members.

### BACKGROUND OF THE INVENTION

1. Field of the Invention

The present invention relates to a clamp pliers, and more particularly to a hose clamp pliers that may quickly replace desired clamping members on the basis of the size or shape of the hose members.

2. Description of the Prior Arts

TW Publication No. M261338 discloses a prior art hose clamp pliers comprising a first pliers body 10 and a second pliers body 20 axially combined together by a pivot pillar 30, the first and second pliers bodies 10, 20 including two corresponding operating segments 14, 24 provided on one ends thereof for connecting with handles 40 respectively and having working segments 12, 22 coupled with front ends thereof individually. The working segments 12, 22 include fitting seats 18, 28 disposed on the front ends thereof for fitting clamping members 50 therein respectively so as to remove hose members.

The clamping members 50 include positioning portions 52 mounted on one ends thereof respectively and include shanks 54, the diameters of which are less than those of the positioning portions 52, coupled on another ends thereof individually. Each of the positioning portions 52 is designed for accommodation various types of hose members, and the shanks 54 insert through the fitting seats 18, 28 and the inner end surfaces of the positioning portions 52 are biased against the inner end surfaces of the fitting seats 18, 28 respectively. Besides, one ends of the shanks 54 project out of the outer end surfaces of the fitting seats 18, 28 individually and the shanks 54 include C-shaped fastening members 56 retained thereon respectively, such that the fastening members 56 allow to confine the clamping members 50 in the fitting seats 18, 28, replacing different sizes or shapes of clamping members 50.

However, in operation, the C-shaped fastening members 56 have to associate with a snap ring pliers to install or remove the hose members, causing tool cost consumption. Furthermore, the user has to remove and install C-shaped fastening members 56 on the shanks 54 repeatedly, occurring an inefficient operation.

The present invention has arisen to mitigate and/or obviate the afore-described disadvantages.

### SUMMARY OF THE INVENTION

The primary object of the present invention is to provide a hose clamp pliers that may quickly install or remove hose members.

In accordance with one aspect of the present invention, there is provided a hose clamp pliers comprising shanks including holes formed therein for receiving compression springs including balls placed on the free ends thereof and pushed out of the shanks thereby for contacting with the outer end surfaces of fitting seats, and by virtue of the inner end surfaces of the fitting seats, clamping members being positioned in the fitting seats, thus quickly replacing different sizes or shapes of clamping members.

In replacement operation of the clamping members, positioning portions of the clamping members are pulled and the shanks thereof are urged to push the balls for moving through the fitting seats respectively. Thereafter, the shanks of another clamping members are inserted into the fitting seats so as to urge the balls to move through the fitting seats for retaining on the outer end surfaces of the fitting seats, thereby enhancing the replacement efficiency.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective diagram illustrating the exploded components of a hose clamp pliers according to the present invention;

FIG. 2 is a perspective diagram illustrating the assembly of the hose clamp pliers according to the present invention;

FIG. 3 is a partial cross sectional diagram illustrating the combination of a fitting seat and a clamping member of the present invention;

FIG. 4 is a perspective diagram illustrating two clamping members of the present invention being in an expansion state;

FIG. 5 is a perspective diagram illustrating different clamping members being replaceably installed onto the hose clamp pliers according to the present invention;

FIG. 6 is a perspective diagram illustrating the assembly of a hose clamp pliers according to a second embodiment of the present invention;

FIG. 7 is a perspective diagram illustrating the exploded components of a hose clamp pliers according to a third embodiment of the present invention;

FIG. 8 is a top plane diagram illustrating the assembly of the hose clamp pliers according to the third embodiment of the present invention.

### DETAILED DESCRIPTION OF THE PREFERRED EMBODIMENT

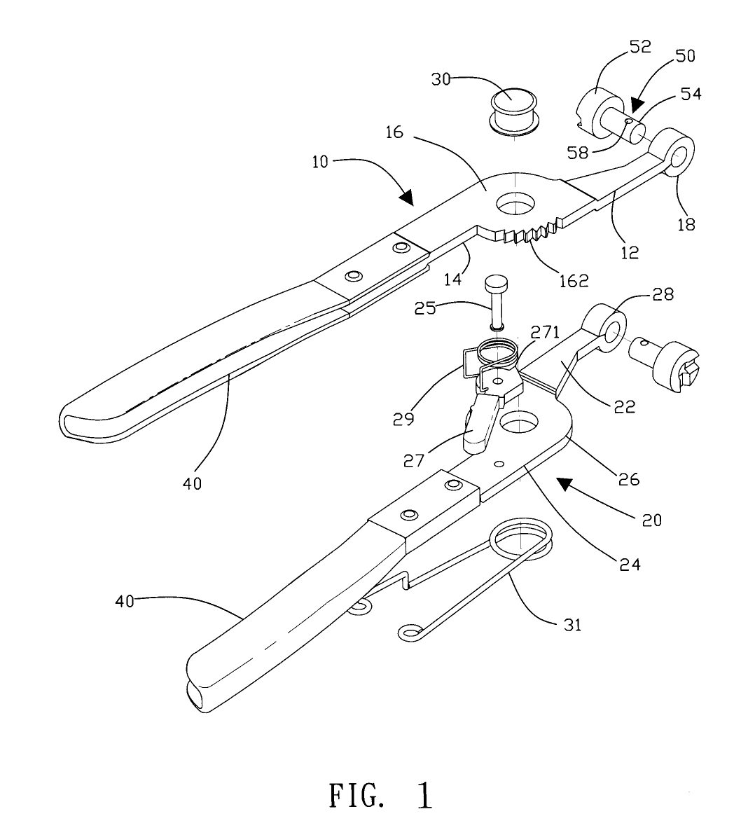

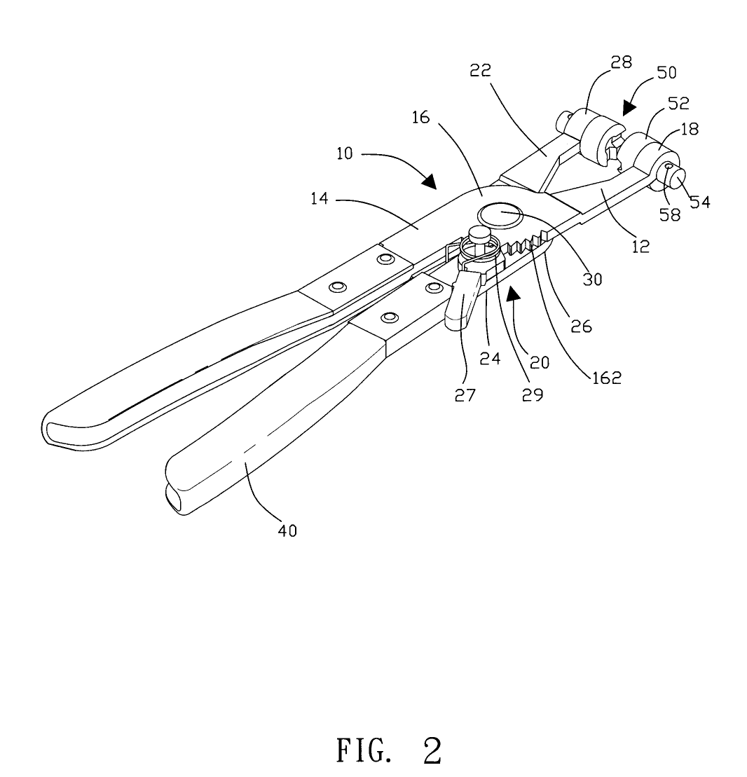

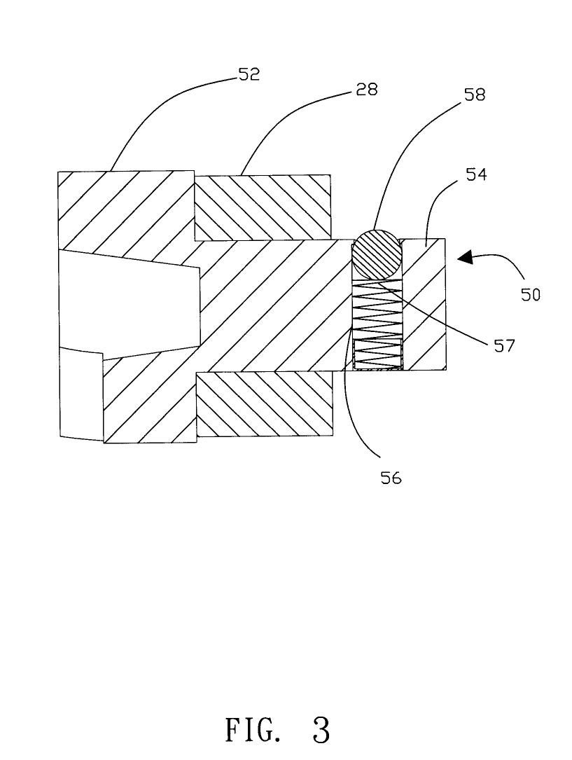

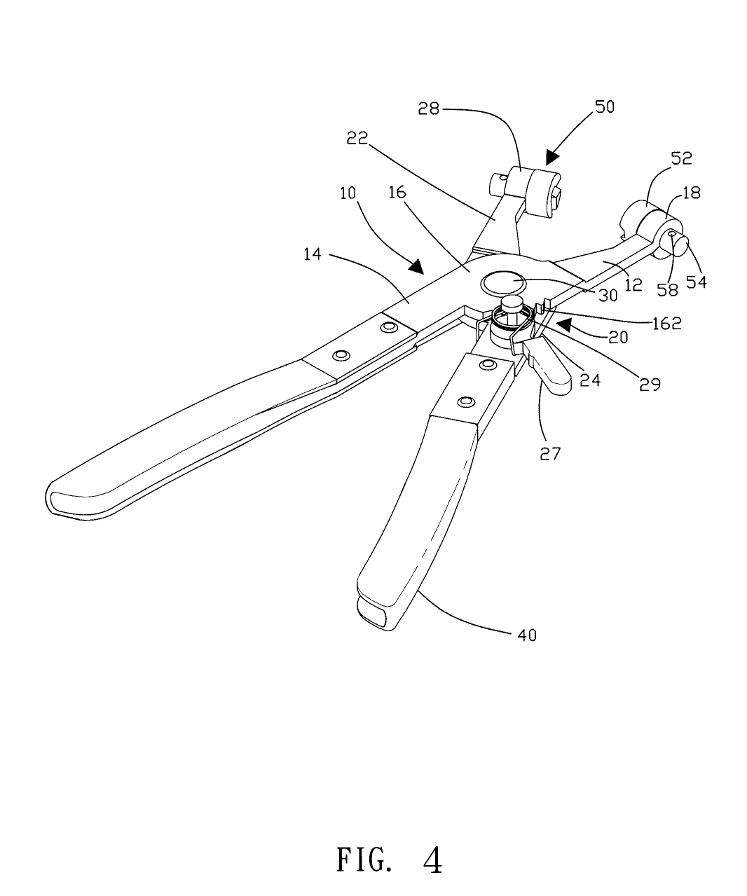

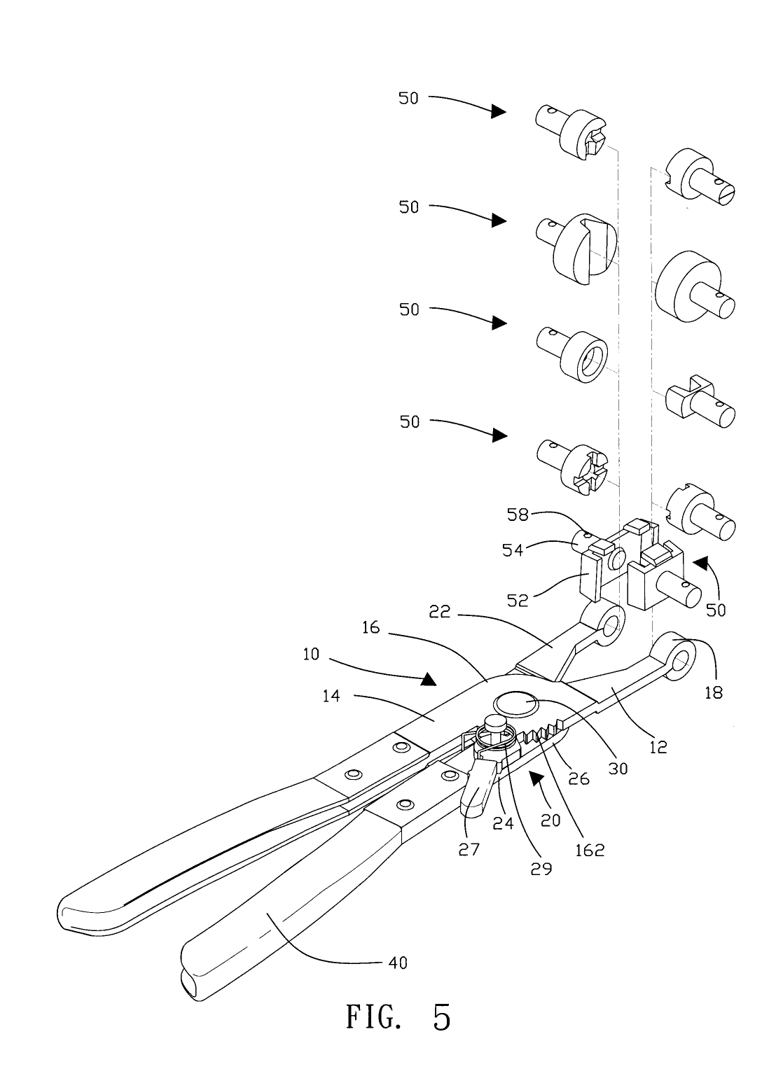

Referring to FIGS. 1-5, a hose clamp pliers in accordance with the present invention comprises a first pliers body 10 and a second pliers body 20 axially combined together by a pivot pillar 30, the first and second pliers bodies 10, 20 including two corresponding operating segments 14, 24 provided on the front ends thereof for connecting with handles 40 respectively and having working segments 12, 22 coupled with the front ends thereof individually. The working segments 12, 22 include fitting seats 18, 28 disposed on the front ends thereof for fitting clamping members 50 therein respectively so as to remove hose members;

the pivot pillar 30 includes a torsion spring 31 fitted thereon, two ends of which abut against the operating segments 14, 24 for random expansion;

the clamping members 50 include positioning portions 52 mounted on one ends thereof respectively and include shanks 54, the diameters of which are less than those of the positioning portions 52, coupled on another ends thereof individually. Each of the positioning portions 52 is designed for accommodation various types of hose members, and the shanks 54 insert through the fitting seats 18, 28 and the inner end surfaces of the positioning portions 52 are biased against the inner end surfaces of the fitting seats 18, 28 respectively. Besides, one ends of the shanks 54 project out of the outer end surfaces of the fitting seats 18, 28 individually;

the first and second pliers bodies 10, 20 abuttingly connect with each other by way of disk-like pieces 16, 26 for the insertion of the pivot pillar 30, and the disk-like piece 16 of the first pliers body 10 includes teeth 162 arranged on the outer periphery thereof, the operating segment 24 of the second pliers body 20 includes a retaining stem 27 axially affixed thereon by using a shaft element 25 and having a hooking portion 271 attached on one end thereof for engaging with the teeth 162 of the disk-like piece 16, and one end of the retaining stem 27 may use the shaft element 25 as it rotating center to control the engagement/disengagement with/from the teeth 162. By means of the torsion spring 31, the two operating segments 14, 24 resiliently expand to control the expansion travel between the working segments 12, 22 so as to remove a large amount of hose members. The shaft element 25 includes a torsion spring 29 fitted thereon for providing a predetermined resilience to another end of the retaining stem 27, such that the hooking portion 271 allows to engage with the teeth 162 of the disk-like piece 16, obtaining the expansion travel of the two working segments 12 and 22, characterize in

the shanks 54 include holes 56 formed therein for receiving compression springs 57 including balls 58 placed on the free ends thereof and pushed out of the shanks 54 thereby for contacting with the outer end surfaces of the fitting seats 18, 28, and by virtue of the inner end surfaces of the fitting seats 18, 28, the clamping members 50 are positioned in the fitting seats 18, 28, thus quickly replacing different sizes or shapes of clamping members 50.

In replacement operation of the clamping members 50, the positioning portions 52 of the clamping members 50 are pulled and the shanks 54 thereof are urged to push the balls 58 for moving through the fitting seats 18, 28 respectively. Thereafter, the shanks 54 of another clamping members 50 are inserted into the fitting seats 18, 28 so as to urge the balls 58 to move through the fitting seats 18, 28 for retaining on the outer end surfaces of the fitting seats 18, 28, thereby enhancing the replacement efficiency.

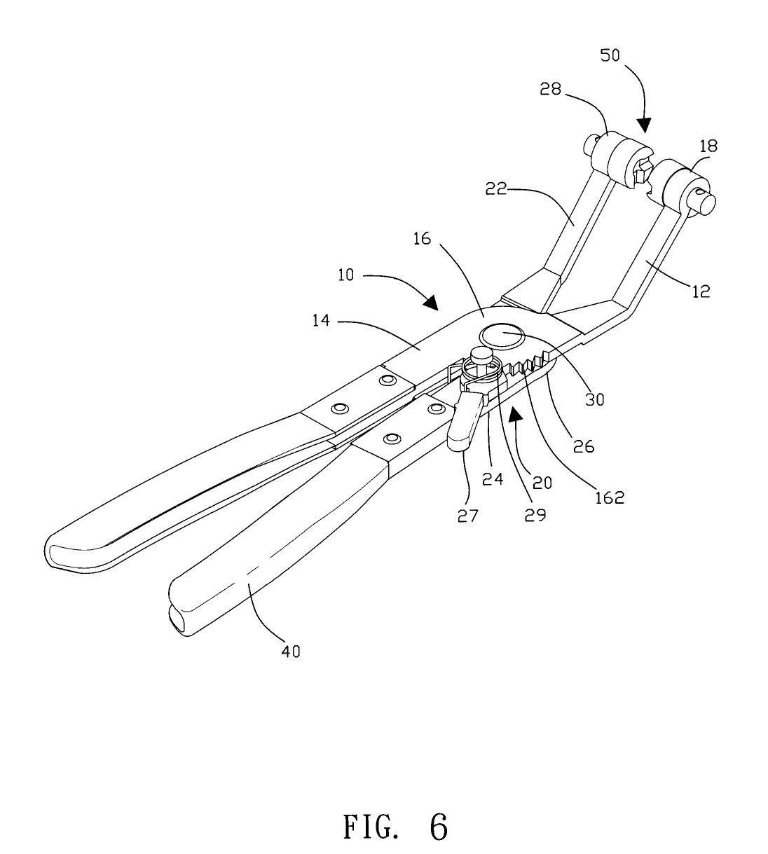

With reference to FIG. 6, in a second embodiment of the present invention, the front ends of the two working segments 12, 22 bently extend upward so that the clamping members (not shown) may be used in a narrow place.

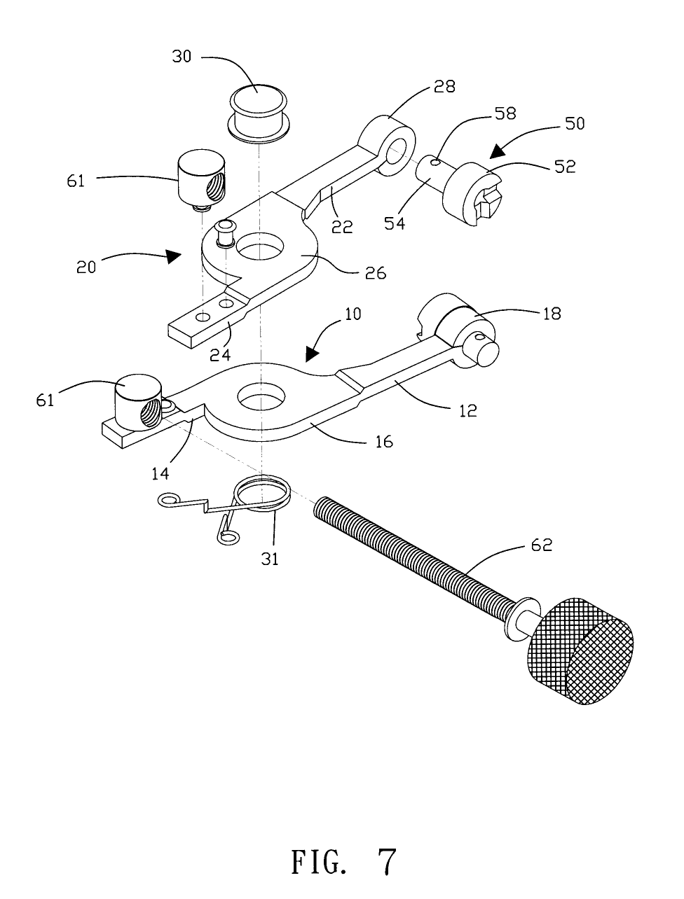

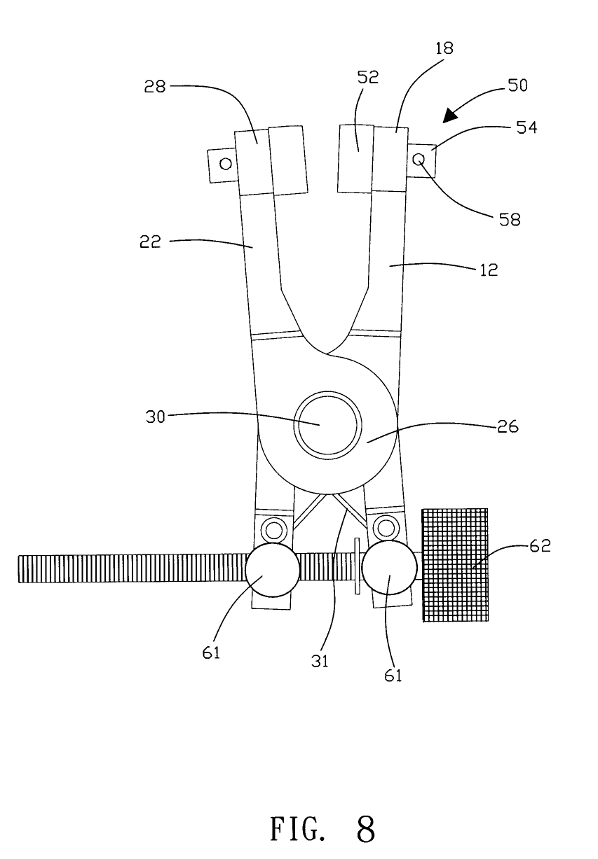

As illustrated in FIGS. 7 and 8, in a third embodiment of the present invention, the operating segments 14, 24 include screw blocks 61 attached thereon for screwing with an adjusting screw 62 respectively, and the two ends of the torsion springs 31 act against the two operating segments 14, 24 individually, hence the screw blocks 61 resiliently displace outward for rotating the adjusting screw 62 to control the travel between the two working segments 12, 22.

The invention is not limited to the above embodiment but various modifications thereof may be made. It will be understood by those skilled in the art that various changes in form and detail may made without departing from the scope and spirit of the present invention.

1. A hose clamp pliers comprising:
a first pliers body and a second pliers body axially combined together by a pivot pillar, said first and second pliers bodies including two corresponding operating segments provided on the front ends thereof respectively and having working segments coupled with the front ends thereof individually, said working segments including fitting seats disposed on the front ends thereof for fitting clamping members therein respectively so as to remove hose members;
said clamping members including positioning portions mounted on one ends thereof respectively and including shanks, the diameters of which are less than those of said positioning portions, coupled on another ends thereof individually, each of said positioning portions being designed for accommodation various types of hose members, said shanks inserting through said fitting seats and the inner end surfaces of said positioning portions being biased against the inner end surfaces of said fitting seats respectively, one ends of said shanks projecting out of the outer end surfaces of said fitting seats individually, characterized in
shanks include holes formed therein for receiving compression springs including balls placed on the free ends thereof and pushed out of said shanks thereby for contacting with the outer end surfaces of said fitting seats, and by virtue of the inner end surfaces of said fitting seats, said clamping members are positioned in said fitting seats, thus quickly replacing different sizes or shapes of said clamping members.

2. The hose clamp pliers as claimed in claim 1, wherein said pivot pillar includes a torsion spring fitted thereon, two ends of which abut against said operating segments for random expansion.

3. The hose clamp pliers as claimed in claim 2, wherein said first and second pliers bodies abuttingly connect with each other by way of disk-like pieces for the insertion of said pivot pillar, and said disk-like piece of said first pliers body includes teeth arranged on the outer periphery thereof, and said operating segment of said second pliers body includes a retaining stem axially affixed thereon by using a shaft element and having a hooking portion attached on one end thereof for engaging with said teeth of said disk-like piece, said shaft element includes a torsion spring fitted thereon for providing a predetermined resilience to another end of said retaining stem, such that said hooking portion allows to engage with said teeth of said disk-like piece.

4. The hose clamp pliers as claimed in claim 2, wherein said operating segments include screw blocks attached thereon for screwing with an adjusting screw respectively.

5. The hose clamp pliers as claimed in claim 2, wherein said operating segments includes handles coupled therewith individually.

6. The hose clamp pliers as claimed in claim 1, wherein the front ends of said two working segments bently extend upward so that said clamping members may be used in a narrow place.

7. The hose clamp pliers as claimed in claim 2, wherein the front ends of said two working segments bently extend upward so that said clamping members may be used in a narrow place.
